(19) United States
(12) Patent Application Publication
(10) Pub. No.: US 2018/0312087 A1
(43) Pub. Date: Nov. 1, 2018

(54) VEHICLE SEAT

(71) Applicant: TACHI-S CO., LTD., Akishima-shi, Tokyo (JP)

(72) Inventors: Atsushi ISHII, Tokyo (JP); Shinichi MIZUNO, Tokyo (JP)

(21) Appl. No.: 15/528,064

(22) PCT Filed: Nov. 12, 2015
(86) PCT No.: PCT/JP2015/081810

§ 371 Date: May 18, 2017

(30) Foreign Application Priority Data
Dec. 25, 2014 (JP) 2014-262250

(51) Int. Cl. B60N 2/58; A47C 31/02

(52) U.S. Cl. CPC B60N 2/5883; A47C 31/02

(57) ABSTRACT

The purpose of the present invention is to provide a vehicle seat provided with beads which bend easily in two dimensions in the plane in which outlet seam sections extend, are durable, and do not readily impart a sense of incongruity to people. This vehicle seat is provided with seat covers (2A, 3A, 4A) which cover the surface of a seat (1). The seat covers (2A, 3A, 4A) are provided with: a plurality of skin members (2A1-4A2); and beads (5A-5G) with which the plurality of skin members (2A1-4A2) are sewn together. The beads (5A-5G) are each formed from: a protrusion; and outlet seam sections which are provided to both sides of the protrusion, and which sew together the skin members (2A1-4A2). The beads (5A-5G) are formed from a woven fabric obtained by weaving fibers.

### TECHNICAL FIELD

The present invention relates to a vehicle seat having welts.

### BACKGROUND ART

As the background art of the present technical field, Japanese Patent Application Laid-Open No. Hei 7-8359 (Patent literature 1) is known. In the Patent literature 1, described is a welt having: a ridge formed of a band-shaped welt main body of synthetic resin and reinforcing fabric joined to the rear surface side of the welt main body, which is formed at the center of the welt main body in the width direction, and which has an approximately semi-circular arc cross section; and sewn allowance portions extended from the both left and right sides of the ridge in the width direction. In the welt, folded portions at ends of skin member are respectively sewn with the reinforcing fabric to the sewn allowance portions on the left and right sides of the ridge (see the abstract).

### CITATION LIST

### Patent Literature

PTL 1: Japanese Patent Application Laid-Open No. Hei 7-8359

### SUMMARY OF INVENTION

### Technical Problem

The skin member of the seat is sewn to the welt. The welt is provided, as design accent, as a linear projection on a ridgeline (range of high portions) of the seat shape. The welt in the Patent literature 1 is made of synthetic resin. The synthetic resin welt is hard, and when a person sits on the seat, or stands up from the seat, it gives a sense of discomfort to the person upon contact with the person. In some cases, there is a possibility that the person feels uncomfortable. Particularly, in a vehicle seat, the person turns the direction on the seat cushion (seat surface) while sits or stands up. Accordingly, the person slides on the welt while moves. Especially in such motion, the welt often gives a sense of discomfort to the person. Further, when the person slides on the welt while moves, the welt is worn out and soon time-related deterioration occurs.

The welt in the Patent literature 1 has a band-shaped structure where the sewn allowance portions are extended from the both left and right sides of the ridge in the width direction. In the welt which has this structure and which is made of synthetic resin, it is difficult to perform two-dimensional bending (hereinbelow, in-plane two-dimensional bending) process in a plane where the sewn allowance portions are extended due to its shape and hardness. Especially in the vehicle seat, in some cases, in-plane two-dimensional bending with a large curvature or winding or nearly winding is required. It is difficult to form the synthetic resin welt having the above-described structure in correspondence with the in-plane two-dimensional bending with a large curvature or winding or nearly winding.

The purpose of the present invention is to provide a vehicle seat having a welt with which the two-dimensional bending is easily performed in the plane where sewn allowance portions are extended, and which has durability, further, which does not often give a sense of discomfort to a person.

### Solution to Problem

To attain the above purpose, the vehicle seat according to the present invention comprises a seat cover covering a seat surface. The seat cover has a plurality of skin members and a welt formed by sewing up the plurality of skin members. The welt comprises a ridge and sewn allowance portions provided on both sides of the ridge for sewing up the skin members. In the vehicle seat, the welt is formed with fiber-woven fabric.

### Advantageous Effects of Invention

According to the present invention, the welt is formed with fiber-woven fabric. This facilitates formation of the welt along various curves and facilitates in-plane two-dimensional bending process. Further, upon contact with a person, the welt is deformed in accordance with the body shape of the person. This prevents action of a strong friction force on the welt. With this configuration, it is possible to provide a vehicle seat with a welt which has durability and which does not give a sense of discomfort to the person.

### BRIEF DESCRIPTION OF DRAWINGS

FIG. 1 is a perspective view of a vehicle seat according to an embodiment of the present invention;

FIG. 2 is a plan view of a welt used in the vehicle seat according to the embodiment of the present invention, showing a status where in-plane two-dimensional bending process is performed;

FIG. 3 is a cross-sectional view of the welt shown in FIG. 2 along a line III-III showing a status where a skin member is sewn;

FIG. 4 is a plan view showing an example of a synthetic resin welt;

FIG. 5 is a diagram showing the in-plane two-dimensional bending in the synthetic resin welt; and

FIG. 6 is a diagram showing an easily workable form of bending in the synthetic resin welt.

### DESCRIPTION OF EMBODIMENT

Hereinbelow, an embodiment according to the present invention will be described.

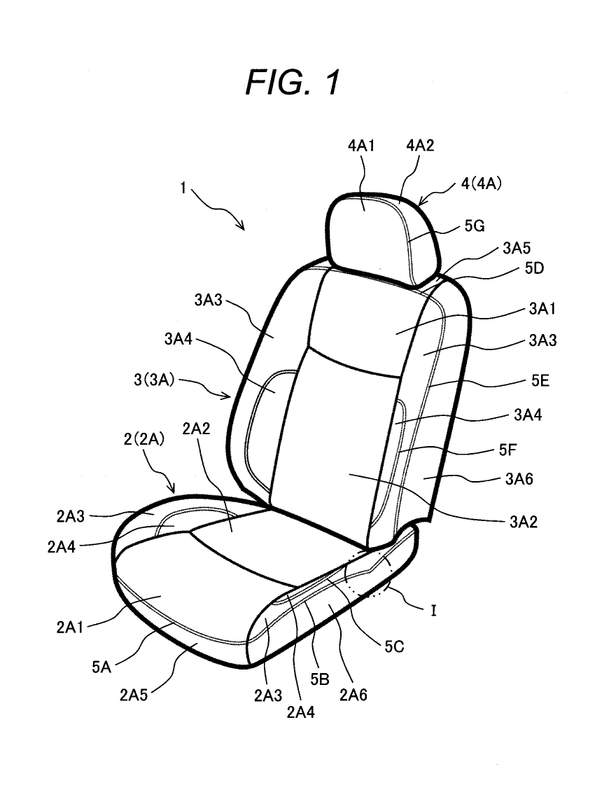

FIG. 1 is a perspective view of a vehicle seat according to the embodiment of the present invention.

As shown in FIG. 1, a vehicle seat 1 has a seat cushion 2 on which a person sits, a seat back 3 which provided upright at a rear end of the seat cushion, and a headrest 4 provided at an upper end of the seat back 3. The seat cushion 2 is attached to a vehicle floor in a status where its position is adjustable in a longitudinal direction. The seat back 3, in a status rotatable about its lower end, is connected to the seat cushion 2. The headrest 4, in a status adjustable in its height position, is attached to the seat back 3. The seat cushion 2, the seat back 3, and the headrest 4 are internally provided with a seat frame as a structural part and a cushion member formed of foamed resin or the like. The surface of the cushion member is covered with a cover. FIG. 1 shows a status where the seat frame and the cushion member are covered with the cover. The seat frame and the cushion member are not shown.

In the vehicle seat according to the present embodiment, the seat cushion 2 is covered with a seat cushion cover 2A. The seat back 3 is covered with a seat back cover 3A, and the headrest 4 is covered with a headrest cover 4A. The seat cushion cover 2A, the seat back cover 3A, and the headrest cover 4A are respectively referred to, otherwise, the seat cushion cover 2A, the seat back cover 3A, and the headrest cover 4A, are generally referred to, as a seat cover.

The seat cushion cover 2A is formed by sewing together a center front skin member (center front trim cover member) 2A1 covering a center front side of the seat surface, a center rear skin member (center rear trim cover member) 2A2 covering a center rear side of the seat surface, a side outer skin member (side outer trim cover member) 2A3 covering a side outer side of the seat surface, a side inner skin member (side inner trim cover member) 2A4 covering a side inner side of the seat surface, a front outer periphery skin member (the front outer periphery trim cover member) 2A5 covering a front outer periphery of the seat surface, and a side outer periphery skin member (side outer periphery trim cover member) 2A6 covering a side outer periphery of the seat surface.

The center front skin member 2A1 and the front outer periphery skin member 2A5 are respectively sewn to a welt 5A, and connected with each other via the welt 5A. The side outer skin member 2A3 and the side outer periphery skin member 2A6 are respectively sewn to a welt 5B, and connected with each other via the welt 5B. The side outer skin member 2A3 and the side inner skin member 2A4 are respectively sewn to a welt 5C, and connected with each other via the welt 5C.

Note that the side outer skin member 2A3, the side inner skin member 2A4, the side outer periphery skin member 2A6, the welt 5B and the welt 5C, in pair, are provided by one pair on the both sides (left and right sides) in the width direction of the vehicle seat 1.

The cut shapes and the divided number of the skin members 2A1 to 2A6 and the arrangement of the welts 5A to 5C may be determined from the viewpoint of design, but are not limited to the above-described configuration. For example, it may be configured such that the side outer skin member 2A3 and the side inner skin member 2A4 are formed in a single skin member, and the welt 5C is not provided.

The seat back cover 3A is formed by sewing together a center upper skin member (center upper trim cover member) 3A1 covering a center upper part of the seat back 3, a center lower skin member (center lower trim cover member) 3A2 covering a center lower part of the seat back 3, a side outer skin member (side outer trim cover member) 3A3 covering the side outer side of the seat back 3, a side inner skin member (side inner trim cover member) 3A4 covering the side inner side of the seat back 3, an upper outer periphery skin member (upper outer periphery trim cover member) 3A5 covering an upper outer periphery of the seat back 3, and a side outer periphery skin member (side outer periphery trim cover member) 3A6 covering a side outer periphery of the seat back 3.

The center upper skin member 3A1 and the upper outer periphery skin member 3A5 are respectively sewn to a welt 5D, and connected with each other via the welt 5D. The side outer skin member 3A3 and the side outer periphery skin member 3A6 are respectively sewn to a welt 5E, and connected with each other via the welt 5E. The side outer skin member 3A3 and the side inner skin member 3A4 are respectively sewn to a welt 5F, and connected with each other via the welt 5F.

Note that the side outer skin member 3A3, the side inner skin member 3A4, the side outer periphery skin member 3A6, the welt 5E and the welt 5F, in pair, are provided by one pair on the both sides (left and right sides) in the width direction of the vehicle seat 1.

The cut shapes and the divided number of the skin members 3A1 to 3A6 and the arrangement of the welts 5D to 5F may be determined from the viewpoint of design, but are not limited to the above-described configuration. For example, it may be configured such that the side outer skin member 3A3 and the side inner skin member 3A4 are formed in a single skin member, and the welt 5F is not provided.

The headrest cover 4A is formed by sewing together a front surface skin member (front surface trim cover member) 4A1 covering a front surface of the headrest 4, and a rear surface skin member (rear surface trim cover member) 4A2 covering a rear surface of the headrest 4. The front surface skin member 4A1 and the rear surface skin member 4A2 are respectively sewn to a welt 5G, and connected with each other via the welt 5G. The cut shapes and the divided number of the skin members 4A1 and 4A2 and the arrangement of the welt 5G may be determined from the viewpoint of design, but are not limited to the above-described configuration.

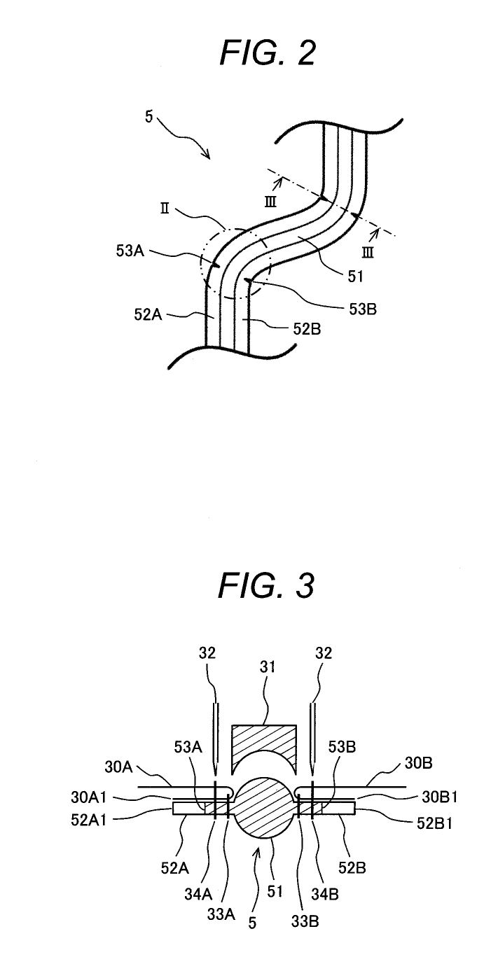

Next, the welt 5 will be described using FIG. 2 and FIG. 3. FIG. 2 is a diagram showing the welt used in the vehicle seat according to the embodiment of the present invention, and is a plan view showing a status where in-plane two-dimensional bending process is performed. FIG. 3 is a cross-sectional view of the welt shown in FIG. 2 along a line showing a status where a skin member is sewn. The above-described welts 5A to 5G have the same structure as that of the welt 5 described hereinbelow.

As shown in FIG. 2, the welt 5 has a ridge 51 and seam allowance portions (extended portions) 52A and 52B. The ridge 51 is formed in a linear shape along a longitudinal direction of the welt 5. Accordingly, in some cases, the ridge 51 is referred to as a linear projection. The welt 5 has the seam allowance portions 52A and 52B on the both sides of the welt 5 in the width direction with respect to the ridge 51.

In a status where the welt 5 has a linear shape, the ridge 51 and the seam allowance portions 52A and 52B exist on one plane. On this plane, the width direction of the welt 5 is orthogonal to the longitudinal direction of the welt 5. The seam allowance portions 52A and 52B are extended from the ridge 51 in the width direction of the welt 5 on the plane. Further, the ridge 51 is formed so as to project from the plane.

Note that FIG. 2 shows a status where within this plane (the plane where the seam allowance portions 52A and 52B are extended), the welt 5 is subjected to the two-dimensional bending (hereinbelow, in-plane two-dimensional bending) process in two portions II-1 and II-2 in the longitudinal direction.

The welt 5 is formed of fiber fabric. That is, the welt 5 is cloth or fabric made by weaving a thin thread type member (fiber). In the present embodiment, in the welt 5, the ridge 51 and the seam allowance portions 52A and 52B are integrally woven. As a type of the fiber, natural fiber including plant fiber, animal fiber and the like, or chemical fiber including synthetic resin and the like may be used. The type of the fiber is not particularly limited as long as a completed welt 5 has flexibility in an out-of-plane direction of the seam allowance portions 52A and 52B to be described later.

In the present embodiment, as described above, the ridge 51 and the seam allowance portions 52A and 52B of the welt 5 are integrally woven. However, it may be configured such that the ridge 51 and the seam allowance portions 52A and 52B are separately woven and sewn together.

In the welt 5, notches 53A and 53B are formed in the seam allowance portions 52A and 52B of the in-plane two-dimensional bending portions II-1 and II-2. The notches 53A and 53B are cuts processed from outer edges of the seam allowance portions 52A and 52B toward the ridge 51 side. In the present embodiment, the notches 53A and 53B are formed by cutting in a V shape (wedge form).

The notches 53A and 53B facilitate the bending processing in the in-plane two-dimensional bending portions II-1 and II-2. Especially on the outer peripheral side of the in-plane two-dimensional bending portion II-1, the seam allowance portion 52A exerts a resisting force against the bending process. The notch 53A of the seam allowance portion 52A eliminates the resisting force with the seam allowance portion 52A by opening upon bending processing. It is possible to omit the notch 53A on the outer peripheral side of the in-plane two-dimensional bending portion II-1 by forming at least the seam allowance portions 52A and 52B of the welt 5 with stretch fabric material.

The seam allowance portions 52A and 52B are formed of fabric material. Accordingly, on the inner peripheral side of the in-plane two-dimensional bending portion II-1, in the easiness of bending process, the existence of the seam allowance portion 52B is not a serious problem as in the case of the outer peripheral side. That is, it is possible to perform in-plane two-dimensional bending process by folding or bending the fabric seam allowance portion 52B. However, in some cases, there is a problem that the folded or bent part of the seam allowance portion 52B impairs the outer appearance or gives a person a sense of discomfort. When such problem occurs, it is desirable that the seam allowance portion 52B on the inner peripheral side of the in-plane two-dimensional bending portion II-1 is also provided with the notch 53B.

As shown in a part I of FIG. 1, in the vehicle seat, the welt 5 (5B) has a portion requiring in-plane two-dimensional bending process with a large curvature or winding or nearly winding. As the welt 5 according to the present embodiment is entirely formed of fabric material, it is possible to easily perform in-plane two-dimensional bending process with a large curvature or winding or nearly winding. As the welt 5 is provided with the notches 53A and 53B, it is possible to further easily perform in-plane two-dimensional bending process with a large curvature or winding or nearly winding.

As described above, it is not necessary to provide the notches 53A and 53B of the seam allowance portions 52A and 52B. As the seam allowance portions 52A and 52B are formed of fabric material, it is possible to form them after the production of the welt 5, in accordance with necessity. For example, upon sewing the skin members and the welt 5, it is possible to process the notches 53A and 53B when it is necessary. When the positions requiring the notches 53A and 53B are previously known, it may be configured such that the notches 53A and 53B are previously provided and then weave the welt 5. The notches 53A and 53B are formed by cutting the seam allowance portions 52A and 52B with scissors or the like.

As shown in FIG. 3, the ridge 51 of the welt 5 is formed to have a circular cross section. The cross-sectional shape of the ridge 51 is not limited to the circular shape but it may be an elliptic shape, a semi-circular arc shape or other shape.

When the skin members 30A and 30B and the welt 5 are sewn together, ends 30A1 and 30B1 of the skin members 30A and 30B and ends 52A1 and 52B1 of the seam allowance portions 52A and 52B of the welt 5 are aligned. In the aligned state, the skin members 30A and 30B and the seam allowance portions 52A and 52B are sewn together (33A and 33B) in the vicinity of the ridge 51. The skin members 30A and 30B are folded in positions closer to the ridge 51 than sewn portions (first sewn portions or first stitch portions) 33A and 33B. Further, the skin members 30A and 30B and the seam allowance portions 52A and 52B are sewn together (34A and 34B) over the folded skin members 30A and 30B in positions closer to the ends 52A1 and 52B1 of the seam allowance portions 52A and 52B than the sewn portions 33A and 33B. In sewn portions (second sewn portions or second stitch portions) 34A and 34B, the skin members 30A and 30B are put one on top of the other.

The second sewn portions 34A and 34B exist on the side of outer edges 52A1 and 52B1 of the welt 5 than the first sewn portions 33A and 33B, and exist on the ridge 51 side than the notches 53A and 53B. In the welt 5, the second stitch portions 34A and 34B, to which the skin members 30A and 30B are sewn, are provided along the ridge 51, between the notches 53A and 53B and the first stitch portions 33A and 33B in the width direction. With this configuration, the second sewn portions 34A and 34B function as anti-fray portions to prevent fray of the fabric material due to formation of the notches 53A and 53B by cutting.

In a sewing process (sewing work) of the first sewn portions 33A and 33B and the second sewn portions 34A and 34B, alignment is performed between a guide member (guide steel) 31 of a sewing machine and the ridge 51 of the welt 5. With this configuration, it is possible to perform partial positioning on a needle 32, arranged in a predetermined position with respect to the guide member 31, in a portion away from the ridge 51 by a predetermined distance. By moving the guide member 31 of the sewing machine along the ridge 51, it is possible to sew up the skin members 30A and 30B and the welt 5 in a portion away from the ridge 51 by a predetermined distance.

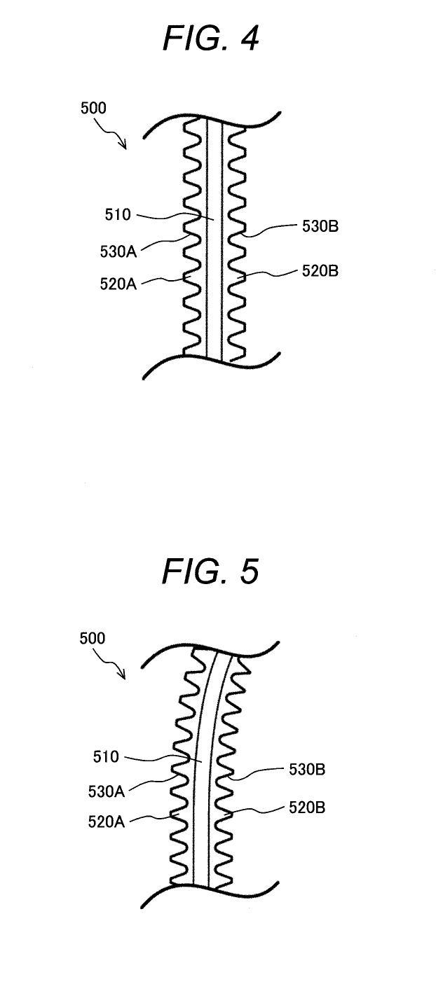

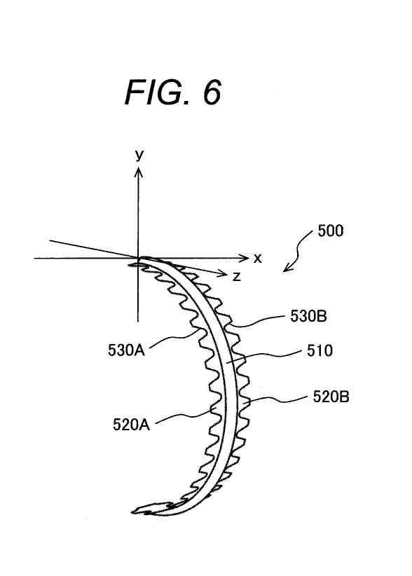

Next, a synthetic resin welt 500 will be described using FIG. 4 to FIG. 6. FIG. 4 is a plan view showing an example of the synthetic resin welt. FIG. 5 is a diagram showing the in-plane two-dimensional bending processed in the synthetic resin welt. FIG. 6 is a diagram showing an easily workable form of bending in the synthetic resin welt.

The welt 500 has a ridge 510 and seam allowance portions 520A and 520B. Wave-shaped portions 539A and 530B are formed in the seam allowance portions 520A and 520B. In the welt 500, the ridge 510 and the seam allowance portions 520A and 520B are formed of synthetic resin. Upon formation of the ridge 510 and the seam allowance portions 520A and 520B, the wave-shaped portions 539A and 530B are integrally formed with the ridge 510 and the seam allowance portions 520A and 520B.

In the welt 500 formed of synthetic resin, when the in-plane two-dimensional bending process as shown in FIG. 5 is performed, it is difficult to form an in-plane two-dimensional bending processed portion with a large curvature or winding or nearly winding in accordance with rigidity of the resin. That is, in FIG. 6, the band-shaped welt 500 formed in a linear shape in an axis z direction, is easily bent in accordance with a curved shape when it is bent toward an axis y direction. On the other hand, when it is bent toward an axis x direction, it is difficult to bend the welt in accordance with a curve having a large curvature. When the welt 500 formed of synthetic resin, having this property, is used in a ridgeline (range of high portions) of the seat shape in the vehicle seat, complicated sewing work to, e.g., twist the welt while arrange it in accordance with the shape, is performed.

As described above, in the present embodiment, the welt 5 is formed with flexible fabric material. It is easy to process the welt in accordance with a curve having a large curvature in the in-plane two-dimensional bending. With this configuration, it is possible to facilitate cover sewing work.

Further, as the synthetic resin welt 500 is hard, it easily gives a person a sense of discomfort by contact with the person when the person sits on the seat or stands up from the seat. In some cases, the person feels uncomfortable. Particularly, in the vehicle seat, the person turns the direction on the seat cushion (seat surface) while sits or stands up. Accordingly, the person moves while sliding on the welt. In this motion, especially the welt often gives a sense of discomfort to the person. Further, when the person moves while sliding on the welt, the welt is worn out and soon time-related deterioration occurs.

In the welt 5 according to the present embodiment, as the welt 5 is formed with flexible fabric material, it is easily deformed along the body shape of a person when the person comes into contact with it. Accordingly, it does not often give the person a sense of discomfort, and mitigates the uncomfortable feeling given to the person. Further, when the person slides on the welt 5 while moves, the friction force applied to the welt is reduced. Accordingly, the wear and time-related deterioration of the welt 5 is reduced.

The welt 5 formed of fabric material has flexibility. When the person sits on the seat, it is possible to mitigate the stress applied to the skin members 30A and 30B. Further, it is possible to control the stretch of the welt 5 in expectation of this effect.

In the synthetic resin welt 500, a mold corresponding to a shape is required. However, in the welt 5 according to the present embodiment, it is possible to form the ridge 51 and the seam allowance portions 52A and 52B in various shapes by changing fiber weaving. Accordingly, it is possible to reduce equipment costs. Further, since it is possible to change the shape by changing the way of fiber weaving, the preparation time accompanying shape change is reduced. Thus design change is easily made.

Further, it is possible to form the welt 5 in various colors or patterns by combining fiber in different colors. Thus it is possible to improve the designability of the vehicle seat.

In the present embodiment, the vehicle seat has been described. It is also possible to use the welt 5 according to the present embodiment as a seat for an airplane or other vehicle, or a seat or the like equipped in a house or building.

### REFERENCE SIGNS LIST

1: vehicle seat, 2: seat cushion, 2A: seat cushion cover, 2A1: center front skin member (center front trim cover member), 2A2: center rear skin member (center rear trim cover member), 2A3: side outer skin member (side outer trim cover member), 2A4: side inner skin member (side inner trim cover member), 2A5: front outer periphery skin member (front outer periphery trim cover member), 2A6: side outer periphery skin member (side outer periphery trim cover member), 3: seat back, 3A: seat back cover, 3A1: center upper skin member (center upper trim cover member), 3A2: center lower skin member (center lower trim cover member), 3A3: side outer skin member (side outer trim cover member), 3A4: side inner skin member (side inner trim cover member), 3A5: upper outer periphery skin member (upper outer periphery trim cover member), 3A6: side outer periphery skin member (side outer periphery trim cover member), 4: headrest, 4A: headrest cover, 4A1: front surface skin member (front surface trim cover member), 4A2: rear surface skin member (rear surface trim cover member), 5A, 5B, 5C, 5D, 5E, 5F, 5G: welt, 30A, 30B: skin member, 30A1, 30B1: end of skin member 30A, 30B, 31: guide member (guide steel), 32: needle, 33A, 33B: first sewn portion, 34A, 34B: second sewn portion, 51: ridge, 52A, 52B: seam allowance portion (extended portion), 52A1, 52B1: end of seam allowance portion 52A, 52B, and 53A, 53B: notch (cut)

1. A vehicle seat comprising a seat cover covering a seat surface, the seat cover having a plurality of skin members and a welt formed by sewing up the plurality of skin members, and the welt comprising a ridge and sewn allowance portions provided on both sides of the ridge for sewing up the skin members,
wherein the welt is formed with fiber-woven fabric.

2. The vehicle seat according to claim 1, wherein the welt has a notch, formed from an outer edge toward the ridge, in the seam allowance portions.

3. The vehicle seat according to claim 2,
wherein in the welt, first stick portions, for stitching the skin members to the respective seam allowance portions provided on both sides of the ridge, are provided along the ridge.

4. The vehicle seat according to claim 3,
wherein in the welt, second stitch portions, for stitching the skin members to the seam allowance portions between the notches and the first stitch portions, is provided along the ridge.

5. The vehicle seat according to claim 4,
wherein the skin members are folded toward an outer edge of the seam allowance portions on the ridge side from the first stitch portions,
and wherein in the second stitch portions, the skin members are stitched to the seam allowance portions from the skin members put one on top of the other.
